(19) United States
(12) Patent Application Publication
(10) Pub. No.: US 2020/0091778 A1
(43) Pub. Date: Mar. 19, 2020

(54) WIRELESS TRANSMISSION SYSTEM AND METHOD THEREOF FOR POWER AND DATA TRANSMISSION

(71) Applicant: ZyXEL Communications Corp., New Taipei City (TW)

(72) Inventors: Chin-Po Liao, Hsinchu City (TW); Ching-Liang Lee, Hsinchu County (TW)

(73) Assignee: ZyXEL Communications Corp., New Taipei City (TW)

(21) Appl. No.: 16/129,815

(22) Filed: Sep. 13, 2018

(51) Int. Cl. H02J 50/80; H02J 50/23; H02J 50/40; H04B 7/0426

(52) U.S. Cl. CPC H02J 50/80; H04B 7/043; H02J 50/40; H02J 50/23

(57) ABSTRACT

A wireless transmission system and a method thereof for power and data transmission are provided. The wireless transmission system includes a first apparatus and a second apparatus. The first apparatus includes a power supply, a wireless charging transmitter and a first communication transceiver. The wireless charging transmitter is coupled to the power supply and transmits the power. The first communication transceiver is coupled to the power supply. The second apparatus includes a wireless charging receiver and a second communication transceiver. The wireless charging receiver receives the power. The second communication transceiver is turned on by the power and performs a data transmission with the first communication transceiver. Accordingly, electric power and data can be transmitted wirelessly, so that the wall of house would not need to be drilled.

### BACKGROUND OF THE INVENTION

### 1. Field of the Invention

The present disclosure relates to communication and electric power transmission, and more particularly, relates to a wireless transmission system and a method thereof for power and data transmission.

### 2. Description of Related Art

Referring to FIG. 1, because of insufficient received signal strength or poor received signal, people may set up an outdoor router 101 to make Internet connected devices (such as computers, smart phones, tablets, etc.) inside the house can perform a data transmission over Internet through a base station 103. The outdoor router 101 may be connected with a Wi-Fi access point (AP) 105 as a bridge for the Internet connected devices. A power over Ethernet (PoE) cable 102 (e.g. category 5 cable) with a PoE injector 104 would be needed, to provide electric power to the outdoor router 101 and allow a data transmission between the outdoor router 101 and the Wi-Fi AP 105. There are many disadvantages and inconvenience while installing the devices in FIG. 1. For example, the outdoor router 101 should be installed with the help of a professional, and the wall of the house may be drilled to make a hole for penetrating the PoE cable 102. In addition, water may be leaked through the hole. Accordingly, the traditional connection manner of the outdoor router 101 should be improved.

### SUMMARY OF THE INVENTION

The present invention is directed to a wireless transmission system and a method thereof for power and data transmission, which provides electric power and transmits data wirelessly, so that the wall of house would not need to be drilled.

In one of the exemplary embodiments, the wireless transmission system includes a first apparatus and a second apparatus. The first apparatus includes a power supply, a wireless charging transmitter and a first communication transceiver. The wireless charging transmitter is coupled to the power supply and transmits the power.

The first communication transceiver is coupled to the power supply. The second apparatus includes a wireless charging receiver and a second communication transceiver. The wireless charging receiver receives the power. The second communication transceiver is turned on by the power and performs a data transmission with the first communication transceiver.

According to one of the exemplary embodiments, the second apparatus includes a transmission interface. The transmission interface is coupled to the second communication transceiver and transmits and receives data between the second communication transceiver and outside environment.

According to one of the exemplary embodiments, the second apparatus includes a power convert device. The power convert device is coupled to the wireless charging receiver and provides the power to outside environment.

According to one of the exemplary embodiments, the transmission interface includes a network interface. The network interface is adapted for connecting with an external device, and transmitting and receiving the data to the external device.

According to one of the exemplary embodiments, the power convert device includes a power interface. The power interface is adapted for connecting with an external device, and provides the power to the external device.

According to one of the exemplary embodiments, the first communication transceiver transmits and receives the data between the second communication transceiver and outside environment.

According to one of the exemplary embodiments, each of the first and second communication transceivers includes a directional antenna emitting signals with a directional beam. The directional beams of the first and second communication transceivers are corresponding to each other in response to a combination of the first apparatus and the second apparatus.

According to one of the exemplary embodiments, the first apparatus further includes an indicator coupled to the first communication transceiver. The indicator responds to an alignment between the directional beams of the first and second communication transceivers.

According to one of the exemplary embodiments, each of the first and second communication transceivers includes a directional antenna, and each of the wireless charging transmitter and the wireless charging receiver includes a coil. In response to a combination of the first apparatus and the second apparatus, the coils of the first and second communication transceivers are corresponded.

In one of the exemplary embodiments, the method for power and data transmission is provided. The method is adapted for a first apparatus and a second apparatus and includes the following steps. The first apparatus transmits power wirelessly. The second apparatus receives the power wirelessly. The second apparatus performs a data transmission with the first apparatus.

According to one of the exemplary embodiments, the step of performing the data transmission includes the following step. The second apparatus transmits and receives data between the first apparatus and outside environment.

According to one of the exemplary embodiments, after the step of receiving the power wirelessly, the method further includes the following step. The second apparatus provides the power to outside environment.

According to one of the exemplary embodiments, the method further includes the following step. The second apparatus provides a network interface, to transmit and receive the data to outside environment.

According to one of the exemplary embodiments, the method further includes the following step. The second apparatus provides a power interface, to forward the power to outside environment.

According to one of the exemplary embodiments, the step of performing the data transmission includes the following step. The first apparatus transmits and receives the data between the second apparatus and outside environment.

According to one of the exemplary embodiments, the method further includes the following step. Each of the first apparatus and the second apparatus emits signals with a directional beam. The directional beams of the first apparatus and the second apparatus are corresponding to each other in response to a combination of the first apparatus and the second apparatus.

According to one of the exemplary embodiments, the method further includes the following step. One of the first apparatus and the second apparatus notifies an alignment result between the directional beams of the first apparatus and the second apparatus to each other.

According to one of the exemplary embodiments, the method further includes the following steps. Each of the first apparatus and the second apparatus provides a directional antenna, and the directional antennas of the first apparatus and the second apparatus are corresponding to each other in response to a combination of the first apparatus and the second apparatus. Each of the first apparatus and the second apparatus provides a coil, and the coils of the first apparatus and the second apparatus are in response to the combination of the first apparatus and the second apparatus.

Based on above, the wireless transmission system and the method thereof for power and data transmission of the embodiments of the disclosure apply wireless charging and wireless communication technologies. In addition, electric power and data can be forwarded to other external device (such as router, AP, switch, IP camera, etc.) connected with the first apparatus or the second apparatus after the first apparatus is aligned with the second apparatus (i.e. the directional beams of two apparatuses are corresponded, and the coils of two apparatuses are also corresponded). Therefore, it is easy for user to install an outdoor router or Wi-Fi AP without drilling a hole on the wall of house, and water leakage can be prevented.

To make the above features and advantages of the disclosure more comprehensible, several embodiments accompanied with drawings are described in detail as follows.

It should be understood, however, that this Summary may not contain all of the aspects and embodiments of the present disclosure, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a traditional way for installing an outdoor router.

FIG. 2 is a block diagram illustrating a wireless transmission system according to one of the exemplary embodiments of the disclosure.

FIG. 3 is a block diagram illustrating communication transceivers according to one of the exemplary embodiments of the disclosure.

FIG. 4 is a block diagram illustrating a wireless charging transmitter and a wireless charging receiver according to one of the exemplary embodiments of the disclosure.

FIG. 5 is a flowchart illustrating a method for power and data transmission according to one of the exemplary embodiments of the disclosure.

FIG. 6A is a schematic diagram illustrating an implementation scenario according to one of the exemplary embodiments of the disclosure.

FIG. 6B is a schematic diagram illustrating another implementation scenario according to one of the exemplary embodiments of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

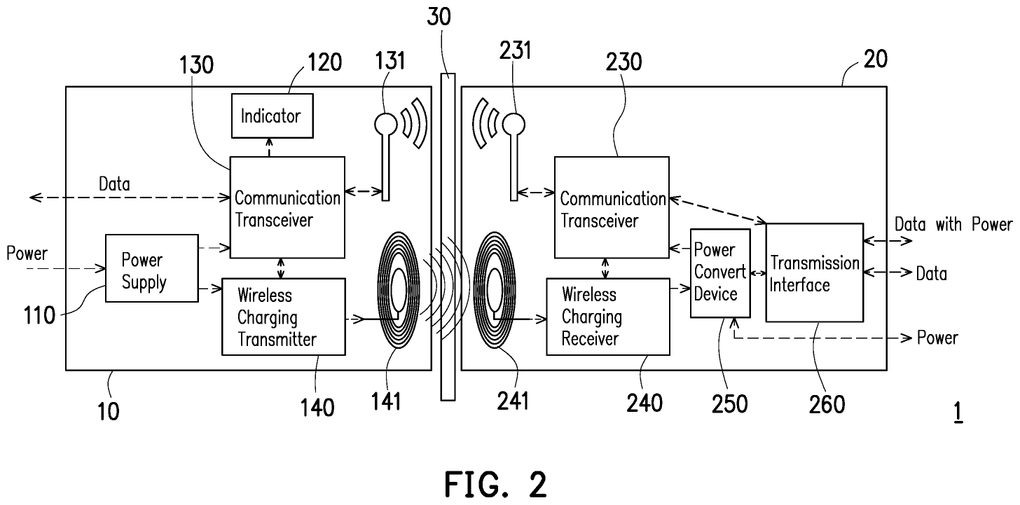

Referring to FIG. 2, FIG. 2 is a block diagram illustrating a wireless transmission system 1 according to one of the exemplary embodiments of the disclosure. The wireless transmission system 1 at least includes, but not limited to, a first apparatus 10 and a second apparatus 20, wherein the first apparatus 10 transfers electric power to the second apparatus 20. The wireless transmission system 1 is adapted for house, office, or any other building.

The first apparatus 10 at least includes, but not limited to, a power supply 110, at least one indicator 120, a communication transceiver 130 and a wireless charging transmitter 140.

The power supply 110 could be any battery, an AC adapter, a DC adapter, an AC power supply, a DC power supply, an AC-to-DC power supply, a switched-mode power supply or any other power supply. The power supply 110 provides (electric) power to electric element of the first apparatus 10.

The indicator 120 could be LED(s), a display (such as LCD, LED display, an OLED display, etc.), a speaker or any other device capable of generating a notification (such as an alarm, a guide, etc.) by sound, light or image. The indicator 120 is coupled to the communication transceiver 130.

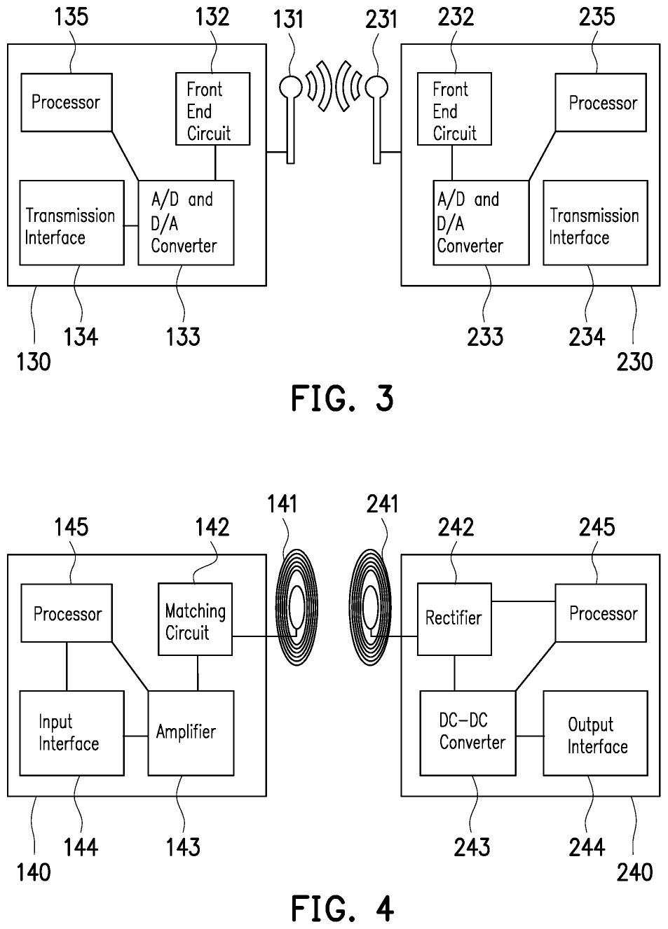

Referring to FIG. 3, FIG. 3 is a block diagram illustrating communication transceivers 130 and 230 according to one of the exemplary embodiments of the disclosure. The communication transceiver 130 at least includes but not limited to, a front-end circuit 132, an analogy to digital (A/D) and digital to analogy (D/A) converter 133, a transmission interface 134 and a processor 135.

The antenna 131 could be a directional antenna, which emitting signals with a directional beam. It should be noticed that, the directional antenna would provide better transmission efficiency in this embodiment of the disclosure; however, an omnidirectional antenna can be applied in other embodiments. The antenna 131 could also be a LED camp, which emitting signals with light, or the antenna 131 could be an optical communication receiver to receive the light.

The front-end circuit 132 receives and transmits signals wirelessly via the antenna 131 and performs operations such as sampling, low noise amplifying, impedance matching, frequency mixing, up-conversion or down-conversion frequency conversion, filtering, amplifying, modulation/de-modulation and so like.

The A/D and D/A converter 133 is coupled to the front-end circuit 132, and the A/D and D/A converter 133 is configured to convert an analog signal format to a digital signal format and convert a digital signal format to an analog signal format.

The transmission interface 134 is coupled to the A/D and D/A converter 133, and the transmission interface 134 includes a power interface (such as PoE, DC interfaces, etc.) to connect with the power supply 110, and a control interface (such as General Purpose Input/Output (GPIO), USB, etc.) to connect the indicator 120. In some embodiments, the transmission interface 134 may further includes a network interface (such as PoE, Ethernet, fiber optic interfaces, etc.) to connect with an external device (such as a Wi-Fi AP, a switch, a router, a gateway, a Bluetooth transmitter/receiver, an Internet connected device (e.g. a computer, a smart TV, a smart speaker, etc.)).

The processor 135 is coupled to the A/D and D/A converter 133, and the processor 135 may be implemented by using a programmable unit, such as a CPU, a micro-processor, a micro-controller, a digital signal processing (DSP) chip, a field programmable gate array (FPGA), and so on. The processer 135 process a digital signal according at least one communication standard (such as Bluetooth, Wi-Fi, ethernet, NFC, etc.).

The wireless charging transmitter 140 may support at least one standard of Wireless Power Consortium (Qi) and AirFuel Alliance including Power Matters Alliance (PMA) and Alliance for Wireless Power (A4WP). Taking magnetic resonance (MR) wireless charging technology as an example, referring to FIG. 4, FIG. 4 is a block diagram illustrating a wireless charging transmitter 140 and a wireless charging receiver 240 according to one of the exemplary embodiments of the disclosure. The wireless charging transmitter 140 may at least include, but not limited, a coil 141, a matching circuit 142, an amplifier 143, an input interface 144 and a processor 145.

The coil 141 is a sensing coil to resonate in response to a specific frequency (such as 6.78 MHz). The matching circuit 142 is a circuit formed by inductors and capacitors in various forms (e.g., serial connection, parallel connection, matrix network, etc.).

The amplifier 143 is coupled to the matching circuit 142, and the amplifier 143 is a circuit that facilitates or maintains a signal output power, such as an operation amplifying circuit, a buffer, or an instrumentation amplifier.

The input interface 144 is coupled to the amplifier 143, and the input interface 144 is a power interface to receive power provided by the power supply 110. The processor 145 is coupled to the amplifier 143 and the input interface 144, and the processor 145 may be a programmable general-purpose or specific-purpose microprocessor, digital signal processor (DSP), programmable controller, application specific integrated circuit (ASIC), other similar components, or a combination thereof. The processor 145 is adapted to handle all software program operations of the wireless charging transmitter 140.

On the other hand, referring to FIG. 2, the second apparatus 20 at least includes, but not limited to, a communication transceiver 230, a wireless charging receiver 240, a power convert device 250 and a transmission interface 260.

Referring to FIG. 3, the communication transceiver 230 at least includes, but not limited to, a front-end circuit 232, an A/D and D/A converter 233, a transmission interface 234 and a processor 235. The detail description of the antenna 231, the front-end circuit 232, the A/D and D/A converter 233, the transmission interface 234 and the processor 235 can be respectively referred to the antenna 131, the front-end circuit 132, the A/D and D/A converter 133, the transmission interface 134 and the processor 135 of the communication transceiver 130 as described before. The differences between the communication transceivers 130 and 230 are that, the power interface of the transmission interface 234 is connected to the power convert device 250 to receive power, and the network interface of the transmission interface 234 is connected to the transmission interface 260 to transmit and receive data.

The wireless charging receiver 240 may support at least one standard of Qi and AirFuel Alliance. Taking MR wireless charging technology as an example, referring to FIG. 4, the wireless charging receiver 240 may at least include, but not limited to, a coil 241, a rectifier 242, a DC-to-DC (DC-DC) converter 243, an output interface 244 and a processor 245.

The coil 241 is a sensing coil to resonate in response to a specific frequency (such as 6.78 MHz), so as to resonate together with the coil 141. The rectifier 242 may be various types of full-wave or half-wave rectifier. The DC-DC converter 243 is coupled to the rectifier 242, and the DC-DC converter 243 is a converter configured to convert a DC power source into another DC power source at a different voltage.

The output interface 244 is coupled to the DC-DC converter 243, and the input interface 244 is a power interface to provide power to the connected power convert device 250. The processor 245 is coupled to the rectifier 242 and the DC-DC converter 243, and the processor 245 may be a programmable general-purpose or specific-purpose microprocessor, DSP, programmable controller, ASIC, other similar components, or a combination thereof. The processor 245 is adapted to handle all software program operations of the wireless charging receiver 240.

The power convert device 250 is coupled to the communication transceiver 230, the wireless charging receiver 240 and the transmission interface 260. The power convert device 250 could be an electric transformer, a DC-to-DC converter, a DC-to-AC converter, a rectifier, an amplifier, or any other electric power conversion device. In the embodiments of the disclosure, the power convert device 250 provides power from the wireless charging receiver 240 to the communication transceiver 230 and the transmission interface 260, and the power convert device 250 provides power to an connected device (such as a router, a Wi-Fi AP, a Bluetooth transmitter/receiver, etc.).

The transmission interface 260 is coupled to the communication transceiver 230 and the power convert device 250, and the transmission interface 260 may include at least one of network interface (such as PoE, ethernet, fiber optic interfaces, etc.). For PoE interface, data and electric power can be transferred between the connected devices. In the embodiments of the disclosure, the transmission interface 260 transmits and receives data between the communication transceiver 230 and a connected device (such as a router, a Wi-Fi AP, a Bluetooth transmitter/receiver, etc.).

Referring to FIG. 2, the first apparatus 10 and the second apparatus 20 can be mounted by magnet or screws on two opposite sides of a medium 30, which does not affect by the electric-field screening, such as cement wall, glass on the window, wooden wall, etc. In other words, the first apparatus 10 and the second apparatus 20 would be separated by the medium 30 at a certain distance, and two apparatuses 10 and 20 would not need to be directly connected with each other. On the other hand, in order to provide a better data and electric power transmission efficiency, some elements are designed at specific positions on the first apparatus 10 and the second apparatus 20. Then, the antennas 131 and 231 can be located corresponding to each other, so that the directional beams of the antennas 131 and 231 are also corresponding to each other. In addition, the coils 141 and 241 can be located corresponding to each other. In other words, in response to the combination of the first apparatus 10 and the second apparatus 20, antennas 131 and 231 are corresponding to each other as same as the coils 141 and 241. Therefore, the gains of the power of the wireless charging transmitter 140 and signals of data of the communication transceivers 130 and 230 can be the largest, and the signals of data would not be interfered with other signals.

It should be notice that, the aforementioned setting up manner of the first apparatus 10 and the second apparatus 20 is merely one of the setting up manners of the disclosure, and those persons skilled in the art can modify the positions and setting up manner of the first apparatus 10 and the second apparatus 20 according to actual requirement. In addition, each of the first apparatus 10 and the second apparatus 20 may have a waterproof and/or dustproof outer shell, and the first apparatus 10 and the second apparatus 20 can be placed outside of building.

In order to make the operation process of the embodiment of the disclosure more comprehensible, several embodiments are provided below to describe in detail the operations of the wireless transmission system 1 in the embodiment of the disclosure.

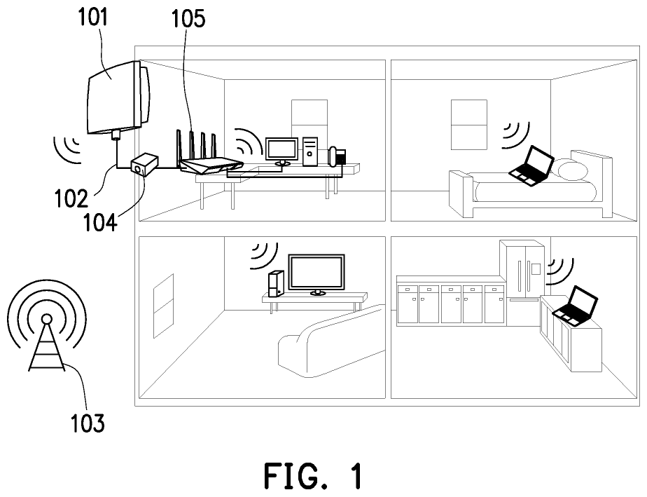

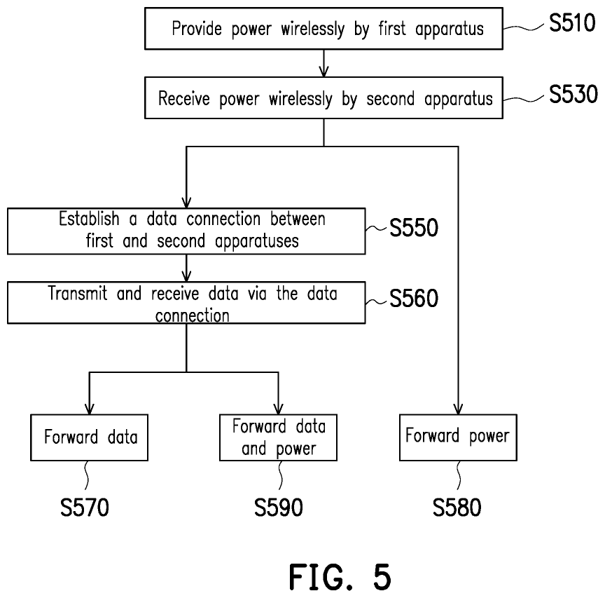

FIG. 5 is a flowchart illustrating a method for power and data transmission according to one of the exemplary embodiments of the disclosure. Referring to FIG. 5, the method of this embodiment is adapted for the first apparatus 10 and the second apparatus 20 of FIG. 1. In the following paragraphs, the method of this embodiment of the disclosure is described with reference to the components of first apparatus 10 and the second apparatus 20 as described in FIGS. 1-4, and it is assumed that the first apparatus 10 and the second apparatus 20 are combined as described before. Nevertheless, the processes of this method may be adjusted according to the actual needs and thus are not limited to the following.

The power supply 110 of the first apparatus 10 provides power to the wireless charging transmitter 140, and the wireless charging transmitter 140 provides the power wirelessly using its supported wireless charging technology (Step S510). Specifically, according to implement example, the power supply 110 may generate the power or receive the power from outside (such as any kind of batteries or power grids). Then, the processor 145 of the wireless charging transmitter 140 controls the input interface 144 to receive the power and the amplifier 143 to amplify the voltage or the current of the power. The power then be transferred through the matching circuit 142 and the coil 141.

The wireless charging receiver 240 of the second apparatus 20 receives the power from the wireless charging transmitter 140 wirelessly using its supported wireless charging technology (Step S530). Specifically, in response to the resonance of coil 241, the processor 245 of the wireless charging receiver 240 controls the rectifier 242 to transform the wave of the power to DC and DC-DC converter 243 to convert the power to a specific voltage. Then, the power was transferred through the output interface 244. It should be noticed that, MR wireless charging technology is an example for easier to explain how the power can be transferred wirelessly. However, those persons skilled in the art can implement another wireless charging technology according to actual requirement, and the disclosure is not limited thereto.

Because the power is supplied to the second apparatus 20, the power convert device 250 can convert the power to a specific voltage and/or current to the communication transceiver 230 of the second apparatus 20, and the communication transceiver 230 can be turned on. Then, the communication transceiver 230 can establish a data connection wirelessly with the communication transceiver 130 using their supported communication technology (such as Bluetooth, Wi-Fi, NFC, LiFi, etc.) (Step S550). Specifically, digital data from processor 235 is converted to analogy signals, and the analogy signals are processed by the front-end circuit 232 and emitted by the antenna 231. Wireless signals are received by the antenna 131 and processed by the front-end circuit 132, to generate analogy signals. The analogy signals would be converted into digital signal, which can be decoded by the processor 135. Similar to the data transmission from the second apparatus 20 to the first apparatus 10, data transmission from the first apparatus 10 to second apparatus 20 can be achieved.

Then, the communication transceivers 130 and 230 can perform a data transmission (i.e. transmit/receive data) with each other via the established data connection (Step S560). After data and electric power can be transmitted wirelessly between the first apparatus 10 and the second apparatus 20, the data and/or the electric power can be further forward to other connected external device outside the wireless transmission system 1. In other words, the wireless transmission system 1 can be a bridge of power and data transmission for external devices.

In one embodiment, to forward data (Step S570), an external device (such as a computer, a switch, a router, etc.) connected with the transmission interface 134 of the communication transceiver 130 may transmit data to the second apparatus 20 and/or receive data from the second apparatus 20 through the communication transceivers 130 and 230 (i.e. transmit and receive data between the external device and the second apparatus 20). Alternatively, in another embodiment, to forward data (Step S570), an external device (such as a computer, a switch, a router, etc.) connected with the transmission interface 260 of the second apparatus 20 may transmit data to the first apparatus 10 and/or receive data from the first apparatus 10 through the communication transceivers 130 and 230 (i.e. transmit and receive data between the external device and the first apparatus 10).

In still another embodiment, to forward data (Step S570), an external device (such as a computer, a switch, a router, etc.) is connected with the transmission interface 134 of the communication transceiver 130, and another external device (such as a computer, a switch, a router, etc.) is connected with the transmission interface 260 of the communication transceiver 230. Then, the two external devices can perform a data transmission with each other through the communication transceivers 130 and 230 (i.e. transmit and receive data between two external devices).

To forward power (Step S580), in one embodiment, an external device (such as a computer, a light, an audio player, etc.) is connected with the power convert device 250 of the second apparatus 20, and the power from the power supply 110 of the first apparatus 10 can be provided to the external device through the wireless charging transmitter 140 and the wireless charging receiver 240 (i.e. forward power to outside of the wireless transmission system 1).

To forward data and power (Step S590), in one embodiment, an external device (such as a computer, a switch, a router, etc.) is connected with the transmission interface 260 of the second apparatus 20 by PoE interface and ethernet cable. The power from the power supply 110 of the first apparatus 10 can be provided to the external device through the wireless charging transmitter 140 and the wireless charging receiver 240. Data from the first apparatus 10 can be transmitted to the external device or data from the external device can be transmitted to the first apparatus 10 (i.e. forward data and power to outside of the wireless transmission system 1).

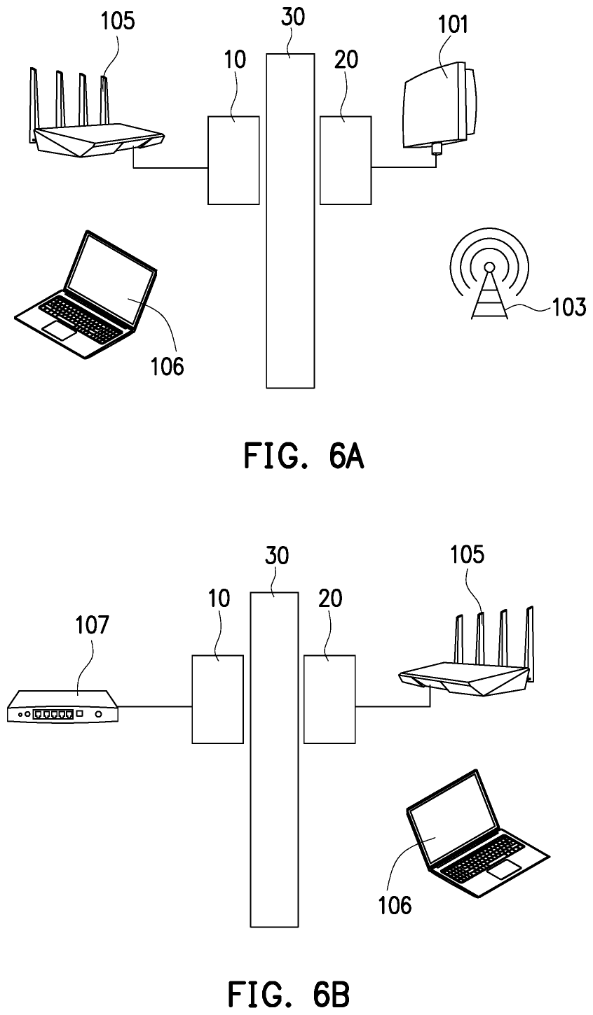

For ease of understanding, two implementation scenarios would be introduced as examples. Referring to FIG. 6A, FIG. 6A is a schematic diagram illustrating an implement scenario according to one of the exemplary embodiments of the disclosure. The first apparatus 10 and the second apparatus 20 are mounted on the medium 30 (taking cement wall as an example). A Wi-Fi AP 105 is connected with the first apparatus 10, and the power supply 110 of the first apparatus 10 is connected with power grids. An outdoor router 101 is connected with the second apparatus 20, so as to provide power to the outdoor router 101. The outdoor router 101 can communicate with the base station 103, and a laptop 106 can access Internet via the Wi-Fi AP 105, the wireless transmission system 1, the outdoor router 101 and the base station 103.

Referring to FIG. 6B, FIG. 6B is a schematic diagram illustrating another implement scenario according to one of the exemplary embodiments of the disclosure. The first apparatus 10 and the second apparatus 20 are mounted on the medium 30 (taking wooden wall as an example). A Wi-Fi AP 105 is connected with the second apparatus 20, and the power supply 110 of the first apparatus 10 is connected with power grids, so as to provide power to the Wi-Fi AP 105. A network access device 107 is connected with the first apparatus 10 and Internet. The laptop 106 can access Internet via the Wi-Fi AP 105, the wireless transmission system 1 and the network access device 106.

Furthermore, as described before, the alignment between the first apparatus 10 and the second apparatus 20 is important to improve the transmission efficiency of data and power. In one embodiment, the indicator 120 can notify/present/indicate an alignment result between the directional beams of the antennas 131 and 231 to each other by light, sound or image. In other words, the indicator 120 can responds to an alignment between the directional beams of the antennas 131 and 231. For example, the communication transceiver 130 can detect received signal strength, and determine whether the received signal strength exceeds a threshold. If the received signal strength exceeds the threshold, the indicator 120 (which is a multiple color LED) presents a green light. If the received signal strength does not exceed the threshold, the indicator 120 presents a red light. It should be noticed that, error rate of data, signal quality or other condition can be used for determining the alignment result between the directional beams of the antennas 131 and 231 based on actual requirement. In addition, in other embodiments, the indicator 120 may be embedded in the second apparatus 20 or both apparatuses 10 and 20.

In summary, the exemplary embodiments described above depicted a wireless transmission system and a method thereof for power and data transmission. The embodiments apply wireless charging and wireless communication technologies. The first apparatus 10 can be set up inside the building, and the second apparatus 20 can be set up outside the building. In addition, electric power and data can be forwarded to other external device (such as router, AP, switch, etc.) connected with the first apparatus or the second apparatus after the first apparatus is aligned with the second apparatus (i.e. the directional beams of two antennas are corresponded, and the coils of two apparatuses are corresponded). Therefore, it is easy for user to install an outdoor router or Wi-Fi AP without drilling a hole on the wall of house, and water leakage can be prevented.

It will be apparent to those persons skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless transmission system, comprising:
a first apparatus, comprising:
a power supply, providing power;
a wireless charging transmitter, coupled to the power supply, and transmitting the power; and
a first communication transceiver, coupled to the power supply; and
a second apparatus, comprising:
a wireless charging receiver, receiving the power; and
a second communication transceiver, performing a data transmission with the first communication transceiver; and wherein the first apparatus transfers the power to the second apparatus.

2. The wireless transmission system according to claim 1, wherein the second apparatus further comprises:
a transmission interface, coupled to the second communication transceiver, and forwarding data between the second communication transceiver and outside environment.

3. The wireless transmission system according to claim 1, wherein the second apparatus further comprises:
a power covert device, coupled to the wireless charging receiver, and providing the power to outside environment.

4. The wireless transmission system according to claim 2, wherein the transmission interface comprises:
a network interface, adapted for connecting with an external device, and forwarding the data to the external device.

5. The wireless transmission system according to claim 2, wherein the transmission interface comprises:
a network interface, adapted for connecting with an external device, and forwarding the data and power to the external device.

6. The wireless transmission system according to claim 3, wherein the power convert device comprises:
a power interface, adapted for connecting with an external device, and providing the power to the external device.

7. The wireless transmission system according to claim 1, wherein the first communication transceiver forwards the data between the second communication transceiver and outside environment.

8. The wireless transmission system according to claim 1, wherein each of the first and second communication transceivers comprises:
a directional antenna, emitting signals with a directional beam, wherein the directional beams of the first and second communication transceivers are corresponding to each other in response to a combination of the first apparatus and the second apparatus.

9. The wireless transmission system according to claim 8, wherein the first apparatus further comprises:
an indicator, coupled to the first communication transceiver, and responding to an alignment between the directional beams of the first and second communication transceivers to each other.

10. The wireless transmission system according to claim 1, wherein
each of the wireless charging transmitter and the wireless charging receiver comprises a coil; and
in response to a combination of the first apparatus and the second apparatus, the coils of the wireless charging transmitter and the wireless charging receiver are corresponded.

11. A method for power and data transmission, adapted for a first apparatus and a second apparatus, and the method comprising:
transmitting, by the first apparatus, power wirelessly;
receiving, by the second apparatus, the power wirelessly; and
performing, by the second apparatus, a data transmission with the first apparatus.

12. The method for power and data transmission according to claim 11, wherein the step of performing the data transmission comprises:
transmitting and receiving, by the second apparatus, data of the data transmission between the first apparatus and outside environment.

13. The method for power and data transmission according to claim 11, after the step of receiving the power wirelessly, the method further comprises:
forwarding, by the second apparatus, the power to outside environment.

14. The method for power and data transmission according to claim 12, further comprising:
providing, by the second apparatus, a network interface, to forward the data to outside environment.

15. The method for power and data transmission according to claim 12, further comprising:
providing, by the second apparatus, a network interface, to forward the data to outside environment.

16. The method for power and data transmission according to claim 14, further comprising:
providing, by the second apparatus, a power interface, to provide the power to outside environment.

17. The method for power and data transmission according to claim 12, wherein the step of performing the data transmission comprises:
transmitting and receiving, by the first apparatus, data of the data transmission between the second apparatus and outside environment.

18. The method for power and data transmission according to claim 12, further comprising:
emitting, by each of the first apparatus and the second apparatus, signals with a directional beam, wherein the directional beams of the first apparatus and the second apparatus correspond to each other in response to a combination of the first apparatus and the second apparatus.

19. The method for power and data transmission according to claim 18, further comprising:
notifying, by one of the the first apparatus and the second apparatus, an alignment result between the directional beams of the first apparatus and the second apparatus to each other.

20. The method for power and data transmission according to claim 12, wherein further comprising:
providing, by each of the first apparatus and the second apparatus, a coil, wherein the coils of first apparatus and the second apparatus are corresponding in response to the combination of the first apparatus and the second apparatus.
